(19) United States
(12) Patent Application Publication
(10) Pub. No.: US 2016/0135364 A1
(43) Pub. Date: May 19, 2016

(54) FERTILIZER INJECTOR

(71) Applicant: Schaffert Manufacturing Company, Inc., Indianola, NE (US)

(72) Inventor: Paul E. Schaffert, Indianola, NE (US)

(21) Appl. No.: 14/542,497

(22) Filed: Nov. 14, 2014

(51) Int. Cl. A01C 23/02

(52) U.S. Cl. CPC A01C 23/023

(57) ABSTRACT

The present disclosure provides a liquid delivery apparatus for a planter unit. The liquid delivery apparatus is used to deliver fertilizer during crop planting. The apparatus is configured to attach to a planting device. The liquid delivery apparatus includes a tube which receives a liquid from a reservoir and delivers that liquid to the ground. The liquid flows through a passage extending down the tube. On the end of the tube proximal to the ground, the tube includes an injector with an aperture extending down a center axis. The aperture has a diameter smaller than a diameter of the passage. The injector also includes a tool receiving aperture that is collinear with the axis. Together the injector and the tube are no larger in diameter than the fertilizer tube alone. In this configuration the delivery apparatus is sufficiently compact and strong to be placed close to the ground without interfering with disks or be permanently deformed by debris.

### TECHNICAL FIELD

The invention relates to agricultural seed planters and drills and, more particularly, to seed planters which include fertilizer tubes adapted to properly place fertilizer in furrows.

### BACKGROUND

It is oftentimes also desirable to provide various liquids in the furrow along with the seeds to facilitate plant growth and the ultimate crop yield. The liquids included in the furrow may be liquid fertilizers, liquid insecticides, liquid starters, inoculants, and water. However, problems can arise when providing liquid directly into the furrow along with the seeds. Drenching the seed in fertilizer may result in burning the seed which has a negative impact on plant growth and the ultimate crop yield. Accordingly, it is desirable to place liquids in the furrow along with the seeds without drenching seeds. Numerous benefits are derived from in-furrow liquid distribution, such as maximizing the effectiveness of the liquid introduced into the furrow, reducing the volume of a particular liquid required to achieve a desired effect, and minimizing the time required for a particular liquid to effect the seed.

Liquid fertilizer placement disks may be added to the planter row units for placing liquid in a separate trench next to the seed furrow. The liquid fertilizer placement disks create a trench about two inches to the side of the seed furrow and about two inches deep and deposit liquid into the trench. This is commonly referred to as 2×2 fertilizer application. The liquid fertilizer disks, however, are cumbersome because they do not accurately direct liquid into the furrow as they are typically too far away from the soil and are too large or cumbersome to get close to the disk and the ground. They instead splash it on equipment and waste fertilizer.

### SUMMARY

As provided herein, a liquid injection apparatus is provided. In accordance with various embodiments, a fertilizer dispensing tool may be attached to a planting device. The tool may include a fertilizer tube having a first end and a second end. The first end may be operable to receive a fertilizer from a fertilizer reservoir. The second end may be operable to deliver fertilizer to the ground through passage extending down the fertilizer tube. The tool may also include an injector which may have an aperture extending down a center axis having a diameter smaller than a diameter of the passage. The injector may include a tool receiving aperture collinear with the axis. The injector is attached to the second end of the fertilizer tube forming an injector end assembly. The injector end assembly may be no larger in diameter than the fertilizer tube alone.

In accordance with various embodiments, the second end of the fertilizer tube may be internally threaded. The injector may be externally threaded. The injector may be received inside the inner diameter of the fertilizer tube. The tool receiving aperture may be operable to thread the injector into the interior diameter of the second end of the fertilizer tube without contacting the external diameter of the injector. The tool receiving aperture may be a hexagonal socket. The injector may include a body having an aperture extending axially there-through. The body of the injector may include an indicator visually apparent when the injector is assembled with the fertilizer tube forming the injector end assembly. The injector aperture size may correspond to the visually apparent indicator. The injector may be operable to be removable from and installable into the fertilizer tube with a single hand tool. The injector end assembly may be attached onto a planter row unit. The second end may be positioned proximal to the ground and formed of a material sufficiently strong to limit permanent deformation when colliding with field debris. The material may be stainless steel.

In accordance with various embodiments, a planter row unit may be operable to deposit a seed in a furrow, close the furrow, and dispense a liquid to the furrow. The planter row unit may include a fertilizer tube having a first end in communication with a fertilizer reservoir and a second end operable to direct the fertilizer to the ground with a passage connecting the first end and the second end. The second end may be positioned proximal to the ground and formed of a material sufficiently strong to limit permanent deformation when colliding with field debris. An injector may be attached to the second end of the fertilizer tube forming an injector end assembly. The injector and fertilizer tube may be no larger in diameter than the fertilizer tube alone. The injector and fertilizer tube may increase the pressure on the fertilizer fluid by constricting the passage through which it flows.

In accordance with various embodiments, the second end of the fertilizer tube may be internally threaded and the injector externally threaded, wherein the injector is received inside the inner diameter of the fertilizer tube. The injector may include an internal tool feature operable to thread the injector into the interior diameter of the second end of the fertilizer tube without contacting the external diameter of the injector. The injector may include a body having an aperture extending axially there-through which is smaller in diameter than the passage. The body of the injector may include an indicator visually apparent when the injector is assembled with the fertilizer tube forming the injector end assembly and the injector aperture size corresponding to the visually apparent indicator. The second end may be positioned less than 5 inches from the ground. The second end may be positioned 1-3 inches to the side of the disk and inject the liquid 1-2 inches into the soil.

Additional embodiments and features are set forth in part in the description that follows, and will become apparent to those skilled in the art upon examination of the specification or may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various embodiments of the disclosure and should not be construed as a complete recitation of the scope of the disclosure, characterized in that:

FIG. 1A is a perspective view of a planter encompassing one embodiment of the liquid distribution apparatus of the present invention, and illustrates a tractor puffing an agricultural planter including a plurality of row units;

FIG. 1B is a perspective view of the liquid distribution tool positioned with respect to a disk as viewed from FIG. 1A.

FIG. 2A is a detailed view of a planter having closing wheels in a V-position that can be followed by a press wheel with the liquid distribution tool attached to the planter between the closing wheels and the press wheel;

FIG. 2B is a rear view of the liquid distribution tool positioned with respect to a concave disk;

FIG. 3A is a perspective view of a liquid distribution tool;

FIG. 3B is a cross section view along section line 4B-4B shown in FIG. 3A;

FIG. 4 is a detailed view of the planter of FIG. 2 showing the attachments of the liquid distribution tool attached to the planter;

FIG. 5A is a side view of a liquid distribution injector; and

FIG. 5B is a bottom view of a liquid distribution injector.

### DETAILED DESCRIPTION

The present disclosure provides an improved liquid delivery apparatus for a planter unit. The liquid delivery apparatus may be used to deliver fertilizer during crop planting. This liquid delivery apparatus may be configured to attach to a planting device. The liquid delivery apparatus may include a tube which receives a liquid from a reservoir and delivers that liquid to the ground. The liquid may flow through a passage extending down the tube. On the end of the tube proximal to the ground the tube may include an injector with an aperture extending down a center axis. The aperture may have a diameter smaller than a diameter of the passage. The injector may also include a tool receiving aperture that is collinear with the axis. Together the injector and the tube may be no larger in diameter than the fertilizer tube alone. In this configuration the delivery apparatus may be sufficiently compact and strong to be placed close to the ground without interfering with disks or be permanently deformed by debris.

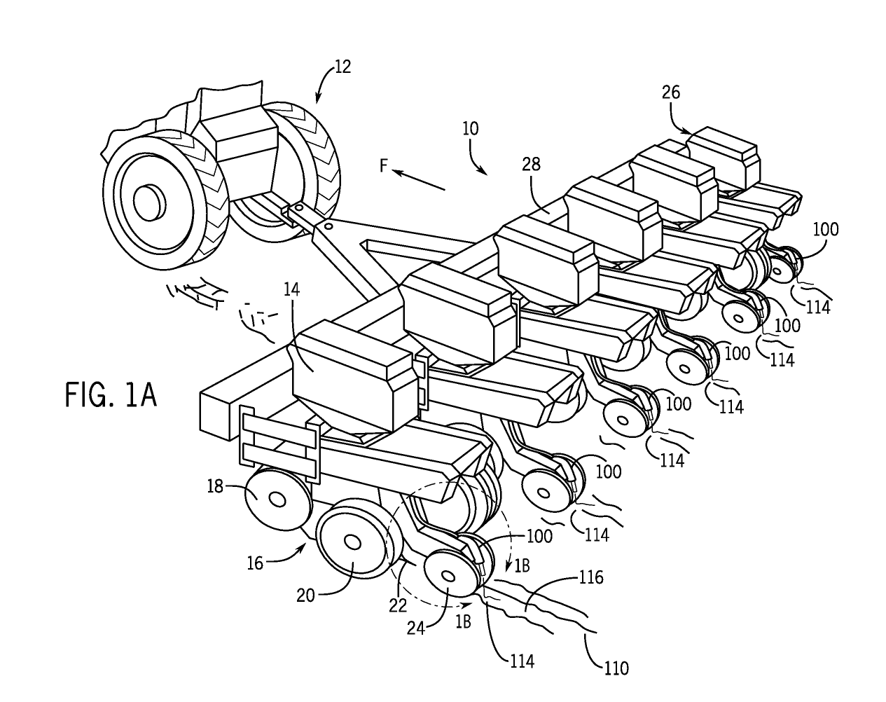

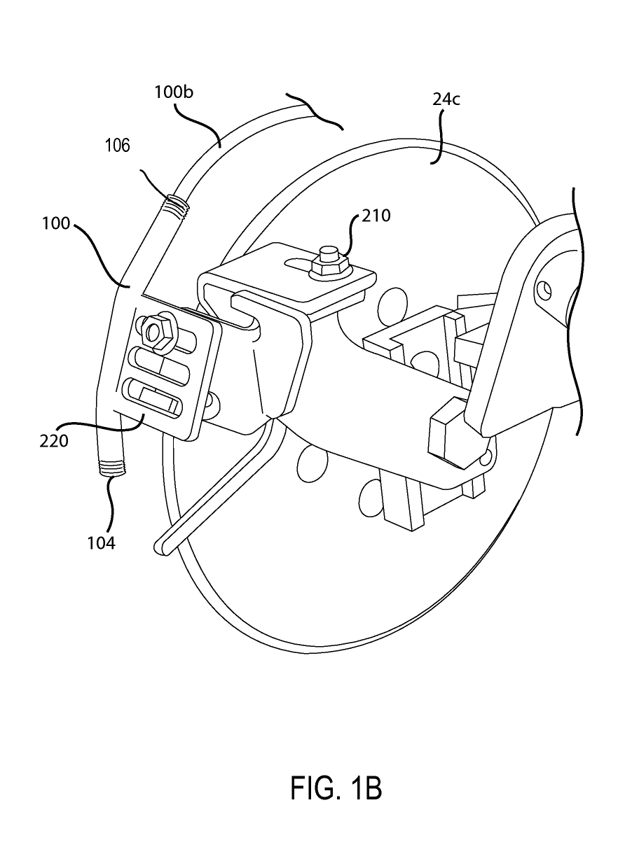

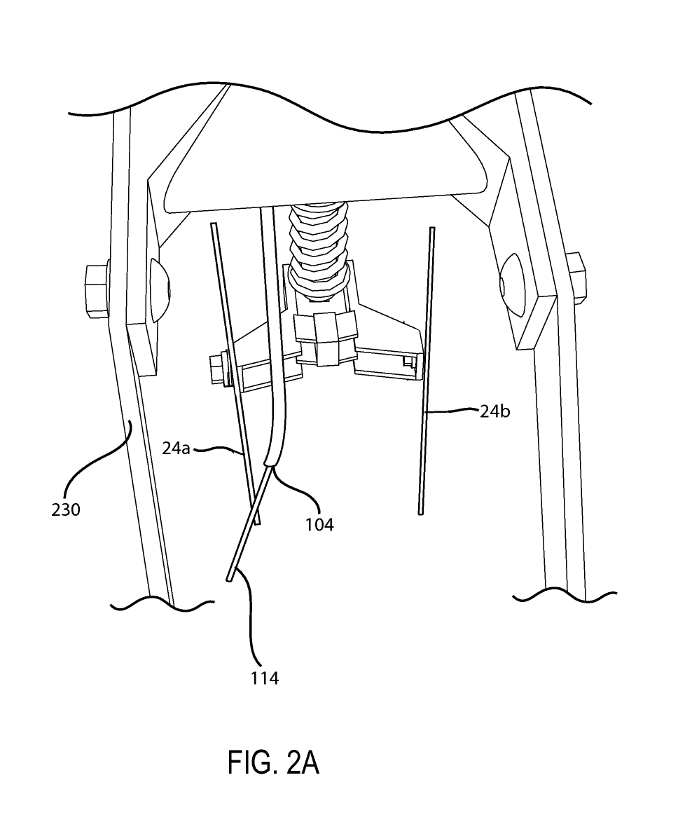

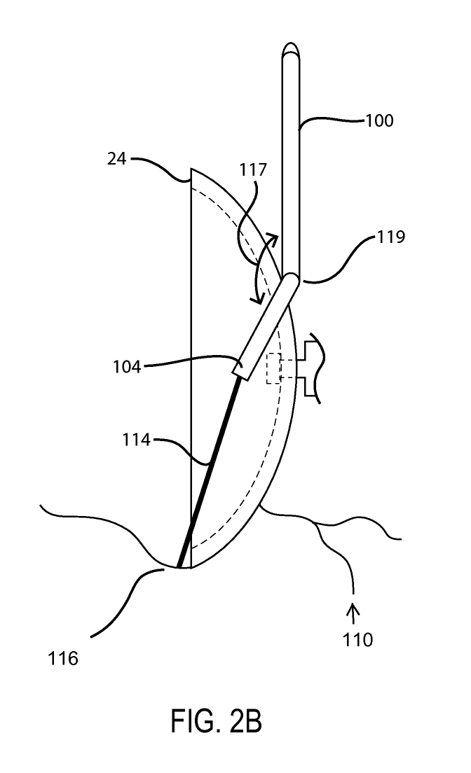

While various embodiments of the liquid distribution apparatus can be used with a variety of planters, drills and liquid supply devices, specific examples of planters are disclosed herein to provide a platform for understanding the various aspects of the liquid distribution apparatus. For example, FIG. 1 illustrates a double disk furrow opener style agricultural planter 10 pulled behind a tractor 12. Such planters are manufactured by John Deere, Kinze, and White. FIG. 2A on the other hand illustrates an IH type planter with V-disks 24a and 24b. Some planters may use a single closing disk, two closing disks (e.g. in a V shape), or one to two closing disks with a press wheel. In these examples, a liquid fertilizer may be placed into the furrow created where the closing disk contacts the soil. Some planters also variously integrate an additional disk that opens a furrow for a liquid fertilizer to be placed into. The apparatus as variously disclosed herein may be operable in any of these variations on planters or can also be operable in other planters as well.

Furthermore, the liquid distribution apparatus is described in a configuration wherein a large liquid container 14 is pulled behind the planter 10 providing a liquid supply to the liquid distribution apparatus through a liquid supply tube 100. The liquid container 14, however, is oftentimes integrated with the planter 10 or the tractor 12. Nonetheless, the liquid distribution apparatus functions equally well regardless of the location of the liquid container 14.

The agricultural planter 10, shown in FIG. 1A, typically includes a number of planter row units 26 mounted on a main frame member 28 and supported by wheels 20. The planter 10 is pulled in a forward direction F by the tractor 12. Each row unit 26 forms a seed furrow 22, deposits seeds evenly along the seed furrow 22, and then closes the seed furrow 22 to form a seed bed 110. Either before closing, while closing, or after closing, the liquid supply tube 100 supplies a liquid 114 into or proximal to the furrow 22. For example, disks 18 may open furrow 22, a seed may be inserted at 16, and 24 may close the furrow. Disks 24 may also form a separate furrow 116 while closing the furrow 22. The liquid distribution apparatus 100 may direct liquid into this furrow 116. This location may be suitable or ideal for certain liquids to be placed relative to the newly planted seed.

The separate furrow 116 may be formed by any of a variety of disks. As shown in FIG. 2B, the disks may be angled away from the direction of travel with the front directed outward and the back directed inward. This may slide dirt over the seed and form a furrow on the outside. The liquid supply tube 100 may be directed to this furrow as shown for example in FIGS. 1B, 2A, and 2B. In some embodiments, the disk may be shaped to form the liquid furrow 116. For example FIG. 2B illustrates a concave disk 24. The convex side of the disk pushes dirt toward furrow 110 and the disk forms furrow 116. As shown the liquid supply tube 100 may have a first portion 119 that has an angle 117. This angle in the supply tube 100 may direct fluid past the disk to the furrow 116. While shown with the concave disk, this angled tube may be applicable with regards to other planter systems as well.

The liquid distributed by the apparatus 100 may include liquids suitable or desirable for use with farming. For example, the liquid may be any of a variety of liquid fertilizers. As some liquid fertilizers cannot or should not be applied directly to a seed, the fertilizers are instead applied to the soil nearby the seed. As indicated above and shown for example in FIGS. 1A and 2B, one example of doing this is by applying the liquid 114 to a furrow formed by the disk 24 (which may be a closer wheel, liquid disk or other planter disk). In some instances, merely applying a surface treatment may be insufficient. As such, the liquid distribution apparatus 100 may apply the liquid below the soil level. This may be done by dragging the liquid distribution apparatus 100 in the soil or it may be done by propelling the liquid below the soil line. In accordance with various embodiments, the liquid distribution apparatus 100 may provide a pressurized stream of liquid 114 to the soil. The stream may be suitably strong to force the liquid 1 inch to 3 inches below the surface. In one example, the steam may be forced to about 2 inches below the surface. In order to provide this pressurized stream, a second end 104 or the liquid distribution apparatus 100 may control the flow of liquid.

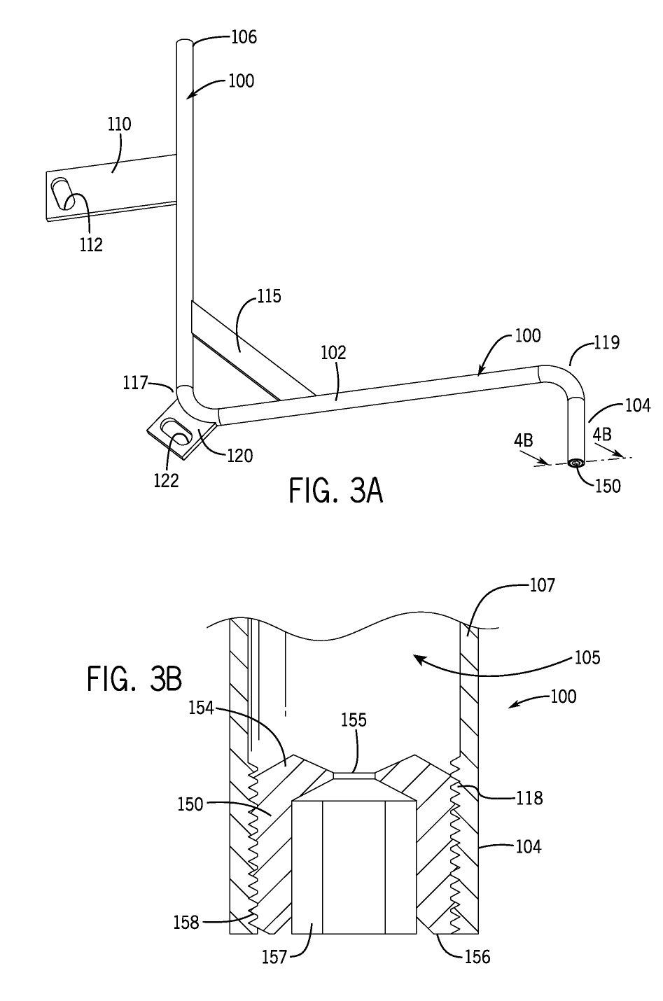

In accordance with various embodiments, the liquid distribution apparatus 100 may be any distribution device operable to deliver liquid from the reservoir 14 to the soil. In accordance with various examples and referring to FIG. 3A, the liquid distribution apparatus 100 may include a body portion 102. The body portion 102 may have a first end 106 and a second end 104. The first end may be connected directly to or through some intermediary device (see e.g. 100b in FIG. 1B, which shows a flexible tube extending from the ridged body 100) to the reservoir 14. In this way the first end 106 may be operable to receive a liquid from the reservoir. The body 102 may include a passage 105 (see FIG. 3B) that connects the first end 106 to the second end 104. The passage may be defined by an outer wall 107 of the body 102. The outer wall 107 may be any shape suitable to the delivery of a liquid there-through such as square, round, oblong, triangular, or the like. In one example, as shown in FIGS. 3A and 3B, the passage 105 may be circular.

The liquid distribution apparatus 100 may follow any shape from end to end. For example, the liquid distribution apparatus 100 may be straight, arcuate, or include a plurality of bends. In one example, as shown in FIG. 3A, the body 102 may be stepped having one or more bends. The bends may allowing the device to be positioned around other planter components and/or provide a stretch of body 102 that is in line with the direction of travel of the planter. In one example, the body 102 may include a first bend 117 and a second bend 119. The first bend may direct a portion of the body 102 in line with the direction of the planter unit. The second bend 119 may direct a portion of the body 102 (e.g. the second end 104) back toward the ground. In another example, as shown in FIG. 1B, the body 100 may be straight, with the first end 106 attached to a separate tube extending to the reservoir and the second end 104 engaging an injector 150.

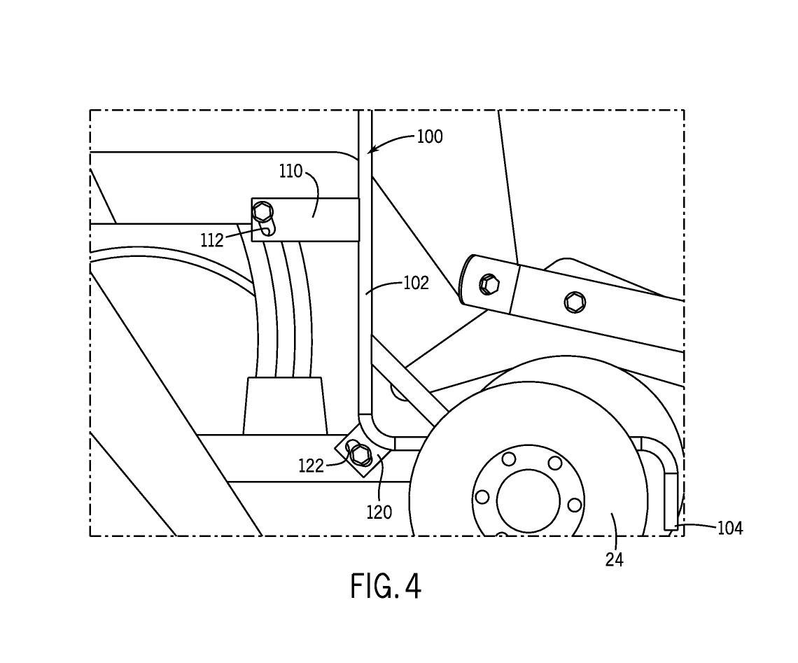

The liquid distribution apparatus 100 may also include one or more mounting features. The features may connect the liquid distribution apparatus 100 to the planter. These mounting features may be adjustable or permanent. For example, as shown in FIG. 3A, the mounting features may include tab 110 and/or tab 120. The tabs 110, 120 may be fastened to the planter unit or permanently fixed thereto (e.g. welding or the like). The tabs 110, 120 may include adjustment features operable to adjust the liquid distribution apparatus 100. The adjustment may be vertical, horizontal, or the combination of both vertical and horizontal adjustment. For example, as shown in FIG. 3A, the tabs 110, 120 may include slots 112, 122. These slots may be positioned angularly with respect to the direction of travel of the planter. In this way the slots may allow for both vertical and horizontal adjustment with respect to the direction of travel. FIG. 4 provides a detailed view of the connection of tabs 110, 120 with slots 112, 122 on the planter unit with the second end 104 positioned proximal to the disk 24.

In accordance with various embodiments, the liquid distribution apparatus 100 may include a single tab 220. This embodiment is shown for example in FIG. 1B. The tab 220 may be configured for mounting the liquid distribution apparatus 100 to the planter. The tab 220 may extend off one side of the body 100. It may also have adjustment slots which allow an adjustable align of the liquid distribution apparatus 100 with its environment. The tab may mound to a bracket 210 that holds a disk scraper or other components. The bracket 210 and body 100 characteristics may define the height of the end 104 from the ground, while the tab slots adjust the tube from side to side to align with the disk or the furrow formed by the disk 24c. As indicated elsewhere, the body of the liquid distribution apparatus 100 may be any length. As shown in FIG. 1B it may be a short length. A tube 100b may extend from end 106 up to the reservoir and the injector may be inserted in the end 104.

As indicated above, the second end 104 of the liquid distribution apparatus 100 may be operable to control the flow of liquid through the device. In various embodiments, the second end may restrict the cross sectional of the passage 105. This may be accomplished by integrally restricting the diameter of the opening of the passage 105 or it may be accomplished by including an injector at the second end 104. In one example, as shown in FIGS. 3A and 3B, the second end 104 may include an injector 150. The injector 150 may be attached to the second end 104 in such a way as to not increase the outside diameter of body 102 at the second end 104. In this way, the injector 150 may be any of a variety of inserts operable to engage the end opening on second end 104. In one example, as shown in FIG. 3B, the second end 104 may have internal threads 118 operable to threadably engage external threads 158 of the injector 150.

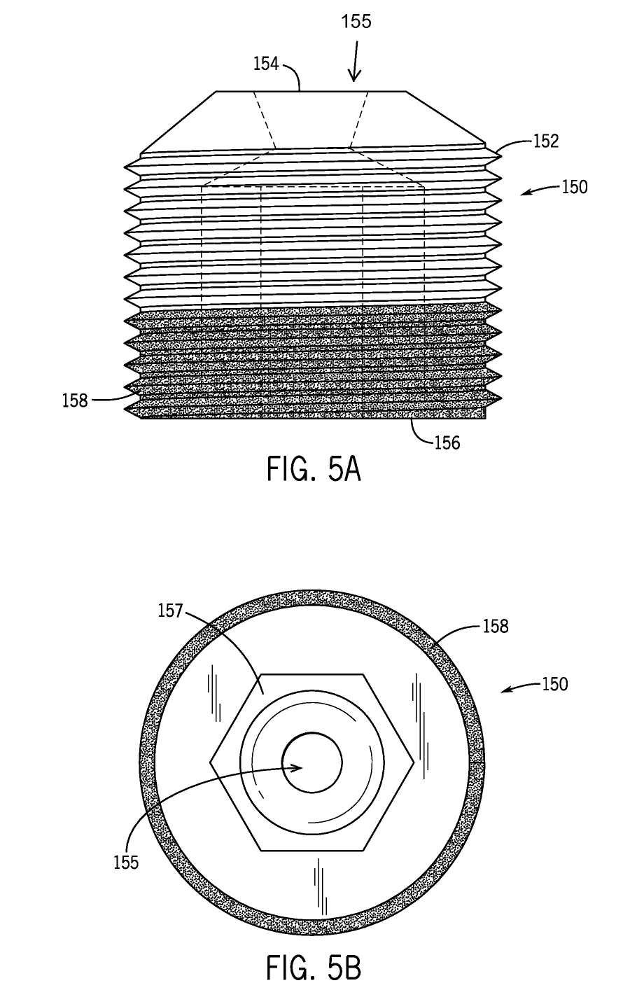

In accordance with various embodiments, as shown in FIGS. 5A and 5B, an injector may have a first end 156 and a second end 154 connected by an externally threaded body 152. The threads 158 may extend the full length or just a portion of the length of the body 152. An aperture 155 may extend between the first end 156 and the second end 154 along a center axis of the injector 150. The aperture may have one or more cross sections along this length. The aperture may be positioned to pressures the liquid upon entrance into the injector 150 at the second end 154 and increase the velocity for better ground penetration. The liquid may travel through the remaining length of the injector 150 at this higher velocity and out the first end 156. In this way, the smallest cross section of the aperture 155 may be proximal to the second end 154. In accordance with various embodiments, the flow of the fluid through the liquid distribution apparatus 100 may be controlled by the cross section of the passage 105 and/or the aperture 155. For example, the aperture 155 may have a smaller diameter than the passage 105. The constricting of the flow passage at the aperture 155 may increase the pressure at the aperture and increase the velocity of the exiting liquid from the injector 150. The aperture 155 may be any of a variety of sizes from 1/16 of an inch up to any diameter less than the diameter of the passage 105.

In accordance with various embodiments, the injector may also include a tool receiving feature 157. The tool receiving feature may allow for very quick changes of the injector 150 off of a planter during actual working conditions. In this way, the injector 150 can be switched with the use of a single hand tool to switch to a larger or smaller aperture 155. The tool receiving feature 157 may be located on the injector 150 in such a way that it can be reached by the tool without engaging the exterior of the tube body 100. The tool receiving feature may be located such that the largest diameter of the injector 150 is still smaller than the internal diameter of the wall 107. The tool receiving feature 157 may be operable to rotate the injector 150 without contacting the exterior surface/threads of the injector. For example, the tool receiving feature 157 may be a socket such as a hexagonal socket shown in FIGS. 3B and 5B. The tool receiving feature 157 may be coaxial with the aperture 155.

In accordance with various embodiments, an indicator 159 may be applied to the first end 156 for the injector 150. The indicator 159 may correspond to aperture 155 sizes allowing for easy switching between various aperture sizes in the field. As the first end 156 may protrude, be flush with, or merely visible from the end 105 of the tube 102 the indicator may be visually apparent. This may allow a user quick recognition and easy changing of the injector, even while in harsh conditions.

As indicated above, the second end 104 may be directed to the ground so that the injector can increase the pressure and velocity of the fluid to force it into the ground. In various examples, the fluid may be directed from above the ground and forced under ground level more than ½ inch. In various examples, the fluid may be directed from above the ground and forced under ground level from 1-3 inches. In various examples, the fluid may be directed from above the ground and forced under the ground level about 2 inches.

The accuracy and the depth of the fluid may also be controlled by positioning the second end 104 of the liquid distribution system 100 proximal to the ground. For example, the second end 104 may be positioned less than 5 inches from the ground. In various examples, the second end 104 may be positioned 3-4 inches from the ground. At any of these proximal heights, the liquid distribution system 100 is going to contact debris in the field. This debris may include high furrows, mud/dirt kicked off of the disk 24 (or other planter equipment), old vegetation or any other element of the environment. In order to not destroy the operation of the liquid distribution system 100, the tube body 102 may be sufficiently strong to not permanently deflect under these circumstances. The liquid distribution system 100 may also maintain its low profile by being no larger in diameter than the tube 102. The tube 102 may be from about ⅛-½ inch in diameter. More particularly, the tube 102 may be from about ¼-⅜ inch in diameter. In order to limit or prevent permanently deflection in these conditions the tube 102 may be manufactured from a strong material such as steel. For example, the material may be stainless steel. In various embodiments, other materials may be used (e.g. aluminum, polymers, etc.) including weaker materials in tradeoff for the benefits of strength and durability under the conditions encountered.

Moreover, as the tube body 102 is the maximum diameter of the liquid distribution system 100 at the second end 104, the tube may be moved significantly closer to disk 24 without creating interference. For example, the second end 104 of tube 102 may be moved a distance of 1-3 inches to the side of the disk 24. In a more particular example, the second end 104 of tube 102 may be moved to a distance of about 2 inches from the side of the disk 24.

Having described several embodiments herein, it will be recognized by those skilled in the art that various modifications, alternative constructions, and equivalents may be used. The various examples and embodiments may be employed separately or they may be mixed and match in combination to form any iteration of the alternatives. Additionally, a number of well-known processes and elements have not been described in order to avoid unnecessarily obscuring the present invention. Accordingly, the above description should not be taken as not limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

We claim:

1. A fertilizer dispensing tool configured to attach to a planting device comprising a fertilizer tube having a first end and a second end with the first end operable to receive a fertilizer from a fertilizer reservoir and the second end operable to deliver fertilizer to the ground through passage extending down the fertilizer tube; and
an injector with an aperture extending down a center axis having a diameter smaller than a diameter of the passage, and a tool receiving aperture collinear with the axis, wherein the injector is attached to the second end of the fertilizer tube forming an injector end assembly, wherein the injector end assembly is no larger in diameter than the fertilizer tube alone.

2. The fertilizer dispensing tool of claim 1, wherein the second end of the fertilizer tube is internally threaded.

3. The fertilizer dispensing tool of claim 1, wherein the injector is externally threaded.

4. The fertilizer dispensing tool of claim 1, wherein the injector is received inside the inner diameter of the fertilizer tube.

5. The fertilizer dispensing tool of claim 4, wherein the tool receiving aperture is operable to thread the injector into the interior diameter of the second end of the fertilizer tube without contacting the external diameter of the injector.

6. The fertilizer dispensing tool of claim 5, wherein the tool receiving aperture is a hexagonal socket.

7. The fertilizer dispensing tool of claim 4, wherein the injector includes a body having an aperture extending axially there-through.

8. The fertilizer dispensing tool of claim 6, wherein the body of the injector includes an indicator visually apparent when the injector is assembled with the fertilizer tube forming the injector end assembly.

9. The fertilizer dispensing tool of claim 8, wherein the injector aperture size corresponds to the visually apparent indicator.

10. The fertilizer dispensing tool of claim 9, wherein the injector is operable to be removable from and installable into the fertilizer tube with a single hand tool.

11. The fertilizer dispensing tool of claim 10, wherein the injector end assembly is attached onto a planter row unit.

12. The fertilizer dispensing tool of claim 1, wherein the second end is positioned proximal to the ground and formed of a material sufficiently strong to limit permanent deformation when colliding with field debris

13. The fertilizer dispensing tool of claim 1, wherein the material is stainless steel.

14. A planter row unit operable to deposit a seed in a furrow, close the furrow, and dispense a liquid to the furrow, the planter row unit comprising:
a fertilizer tube having a first end in communication with a fertilizer reservoir and a second end operable to direct the fertilizer to the ground with a passage connecting the first end and the second end, wherein the second end is positioned proximal to the ground and formed of a material sufficiently strong to limit permanent deformation when colliding with field debris; and
an injector attached to the second end of the fertilizer tube forming an injector end assembly, wherein the injector end assembly is no larger in diameter than the fertilizer tube alone and increases the pressure on the fertilizer fluid by constricting the passage through which it flows.

15. The planter row unit of claim 14, wherein the second end of the fertilizer tube is internally threaded and the injector is externally threaded, wherein the injector is received inside the inner diameter of the fertilizer tube.

16. The fertilizer dispensing tool of claim 14, wherein the injector includes an internal tool feature operable to thread the injector into the interior diameter of the second end of the fertilizer tube without contacting the external diameter of the injector.

17. The fertilizer dispensing tool of claim 14, wherein the injector includes a body having an aperture extending axially there-through which is smaller in diameter than the passage.

18. The fertilizer dispensing tool of claim 17, wherein the body of the injector includes an indicator visually apparent when the injector is assembled with the fertilizer tube forming the injector end assembly and the injector aperture size corresponds to the visually apparent indicator.

19. The fertilizer dispensing tool of claim 14, wherein the second end is positioned less than 5 inches from the ground.

20. The fertilizer dispensing tool of claim 14, wherein the second end is positioned 1-3 inches to the side of the disk and injects the liquid 1-2 inches into the soil.
